(19) United States
(12) Patent Application Publication
(10) Pub. No.: US 2026/0034024 A1
(43) Pub. Date: Feb. 5, 2026

(54) MUSCLE STRENGTH IMPROVEMENT DEVICE AND PROGRAM

(71) Applicant: NATIONAL UNIVERSITY CORPORATION TOKAI NATIONAL HIGHER EDUCATION AND RESEARCH SYSTEM, Nagoya-shi, Aichi (JP)

(72) Inventors: Masashi KATO, Nagoya-shi, Aichi (JP); Nobutaka OHGAMI, Nagoya-shi, Aichi (JP)

(21) Appl. No.: 18/993,295

(22) PCT Filed: Mar. 14, 2023
(86) PCT No.: PCT/JP2023/009899

§ 371 Date: Jan. 10, 2025

(30) Foreign Application Priority Data
Jul. 13, 2022 (JP) 2022-112197

(51) Int. Cl. A61H 23/02

(52) U.S. Cl. CPC A61H 23/0236; A61H 2201/5005

(57) ABSTRACT

A muscle strength improvement device 1 is disclosed that generates a sound stimulus to improve muscle strength. The frequency of the sound stimulus changes over time.

### FIELD

The present disclosure relates to a technology for improving muscle strength using a sound stimulus.

### BACKGROUND

The present inventors have discovered that sound stimulation affects blood flow and have developed a blood flow promotion device utilizing sound stimulation (Patent Document 1). This blood flow promotion device promotes blood circulation in the living body by generating a sound (pure tone) stimulus at a specific frequency between 5 Hz and 250 Hz. It is anticipated to provide improvement effects for symptoms caused by blood flow disorders, such as cold sensitivity, pressure ulcers, Raynaud's phenomenon, and diabetic gangrene.

Additionally, Non-Patent Document 1 demonstrates that blood flow volume in skeletal muscle, which is related to muscle strength, correlates with the blood flow volume in the skin.

### RELATED ART DOCUMENTS, PATENT DOCUMENTS

### Patent Document

[Patent Document 1] International Publication No. WO 2020/129433

### Non-Patent Document

[Non-Patent Document 1] Bartlett, et al., “Impact of cutaneous blood flow on NIR-DCS measures of skeletal muscle blood flow index”. Journal of Applied Physiology. 2021

### SUMMARY OF THE INVENTION

### Technical Problem

In view of the above, the present inventors hypothesized that the conventional blood flow promotion device described in Patent Document 1 could also be expected to improve muscle strength. To test the muscle strength improvement effect of sound stimulus, experiments were conducted using mice. Specifically, an electrical stimulus was applied to the hind limbs of 6 mice to induce 50 muscle contractions, during which the contractile force was measured. Subsequently, the mice were allowed to rest for 24 hours. After the rest period, 3 mice in the sound stimulus group (Sound) were exposed to a pure tone stimulus with a sound pressure level of 85 dBZ and a frequency of 70 Hz for one minute, while the other 3 mice in the control group (Control) were not subjected to any sound stimulus. Thereafter, an electrical stimulus was applied 50 times to the hind limbs of all the mice, and the contractile force was measured during this process.

FIG. 10(a) is a graph showing the contractile force in response to electrical stimulus before the rest period. FIG. 10(b) is a graph comparing the contractile force (average value) during the last 5 muscle contractions (46th to 50th) in response to electrical stimulus before the rest period between the control group and the sound stimulus group, with the contractile force of the control group set to 1. In the measurements taken before the rest period, there was no significant difference in contractile force between the control group and the sound stimulus group. In other words, the control group and the sound stimulus group originally had approximately the same muscle strength.

FIG. 10(c) is a graph showing the contractile force in response to electrical stimulus after the rest period. FIG. 10(d) is a graph comparing the contractile force (average value) during the last 5 muscle contractions (46th to 50th) in response to electrical stimulus after the rest period between the control group and the sound stimulus group, with the contractile force of the control group set to 1. In the measurements taken after the rest period, there was also no significant difference in contractile force between the control group and the sound stimulus group. In other words, with the conventional blood flow promotion device, no muscle strength improvement effect from sound stimulus was observed.

The present disclosure has been made to solve the above problem, and its objective is to improve muscle strength through sound stimulus.

### Solution to Problem

In light of the above objective, the present inventors conducted extensive research and, as a result, discovered that the above problem can be solved by varying the frequency of the sound stimulus. That is, the present disclosure involves the following aspects.

### Clause 1

A muscle strength improvement device that generates a sound stimulus for improving muscle strength,
wherein the frequency of the sound stimulus changes over time.

### Clause 2

The muscle strength improvement device according to clause 1, wherein the frequency is 140 Hz or less.

### Clause 3

The muscle strength improvement device according to clause 1,
wherein the frequency is 100 Hz or less.

### Clause 4

The muscle strength improvement device according to clause 1, wherein the difference between the maximum value and the minimum value of the frequency is 60 Hz or less.

### Clause 5

The muscle strength improvement device according to clause 1, wherein the difference between the maximum value and the minimum value of the frequency is 10 Hz or less.

### Clause 6

The muscle strength improvement device according to any one of clauses 1 to 5, wherein the frequency changes periodically.

### Clause 7

The muscle strength improvement device according to any one of clauses 1 to 5, wherein the frequency changes continuously.

### Clause 8

A program for enabling a computer to implement a function for generating a sound stimulus to improve muscle strength,
wherein the frequency of the sound stimulus changes over time.

### Effect of the Invention

According to the present disclosure, muscle strength can be improved through a sound stimulus.

### BRIEF DESCRIPTION OF THE DRAWINGS

FIG. 1(a) is a block diagram illustrating the configuration of a muscle strength improvement device 1 according to an embodiment of the present disclosure.

FIG. 1(b) is a schematic diagram showing the configuration of the muscle strength improvement device 1.

FIG. 2(a) is a graph showing an example of the waveform of the sound stimulus.

FIG. 2(b) is a graph showing a variation of the waveform of the sound stimulus.

FIG. 3(a) is a graph showing the reduction rate of contractile force relative to the number of muscle contractions before (pre-rest) and after stimulation in the pure tone stimulus group.

FIG. 3(b) is a graph showing the average reduction rate of contractile force for muscle contractions in response to the 38th-40th electrical stimuli before and after stimulation in the pure tone stimulus group.

FIG. 3(c) is a graph showing the reduction rate of contractile force relative to the number of muscle contractions before and after stimulation in the sweep tone stimulus group.

FIG. 3(d) is a graph showing the average reduction rate of contractile force for muscle contractions in response to the 31st-33rd electrical stimuli before and after stimulation in the sweep tone stimulus group.

FIG. 4(a) is a graph showing the contractile force relative to the number of muscle contractions before and after stimulation in 6 normal mice (WT) without inner ear dysfunction.

FIG. 4(b) is a graph showing the contractile force relative to the number of muscle contractions before and after stimulation in 5 inner-ear-damaged mice.

FIG. 4(c) is a graph comparing the shift in the average contractile force during the last 6 muscle contractions (75th-80th) before and after stimulation between normal mice and inner-ear-damaged mice.

FIG. 5 is a graph showing the muscle strength (average contractile force) at the start of the experiment, after the first test, and after the second test in the tail suspension stimulus group, the tail suspension non-stimulus group, and the control group.

FIG. 6(a) is a cross-sectional image of the soleus muscle in the control group.

FIG. 6(b) is a cross-sectional image of the soleus muscle in the tail suspension non-stimulus group.

FIG. 6(c) is a cross-sectional image of the soleus muscle in the tail suspension stimulus group.

FIG. 6(d) is a graph showing the average cross-sectional area of the soleus muscle in the control group, the tail suspension non-stimulus group, and the tail suspension stimulus group.

FIG. 7(a) is a cross-sectional image of the plantar muscle in the control group.

FIG. 7(b) is a cross-sectional image of the plantar muscle in the tail suspension non-stimulus group.

FIG. 7(c) is a cross-sectional image of the plantar muscle in the tail suspension stimulus group.

FIG. 7(d) is a graph showing the proportion of slow-twitch fibers in the plantar muscle in the control group, the tail suspension non-stimulus group, and the tail suspension stimulus group.

FIG. 7(e) is a graph showing the proportion of fast-twitch fibers in the plantar muscle in the control group, the tail suspension non-stimulus group, and the tail suspension stimulus group.

FIG. 8(a) is an explanatory diagram of an experiment (standing heel-raise test) conducted to verify the recovery effect of sound stimulus on muscle fatigue in humans.

FIG. 8(b) is an explanatory diagram of an experiment (standing heel-raise test) conducted to verify the recovery effect of sound stimulus on muscle fatigue in humans.

FIG. 9(a) is a graph showing the evaluation results of muscle fatigue in the pure tone stimulus group.

FIG. 9(b) is a graph showing the evaluation results of muscle fatigue in the sweep tone stimulus group.

FIG. 10(a) is a graph showing the contractile force in response to electrical stimuli before rest.

FIG. 10(b) is a graph comparing the contractile force (average values) of the control group and the sound stimulus group during the last 5 contractions (46th-50th) before rest.

FIG. 10(c) is a graph showing the contractile force in response to electrical stimuli after rest.

FIG. 10(d) is a graph comparing the contractile force (average values) of the control group and the sound stimulus group during the last 5 contractions (46th-50th) after rest.

FIG. 11 is a graph showing the relationship between the frequency of sound stimulus applied to mice and the increase rate in skin blood flow.

FIG. 12 is a graph comparing the vibration levels of the stage in the XYZ-axis directions where the mice are placed, with and without the application of sound stimulus.

FIG. 13 is a graph showing the relationship between the cycle time of sweep tones applied to mice and the increase rate in skin blood flow.

FIG. 14 is a graph showing the relationship between the frequency range of sweep tones applied to mice and the increase rate in blood flow in muscle tissues.

### DESCRIPTION OF EMBODIMENTS

The following describes an embodiment of the present disclosure with reference to the accompanying drawings. It should be noted that the present disclosure is not limited to the embodiment described below, and various modifications may be made without departing from the scope and spirit of the disclosure.

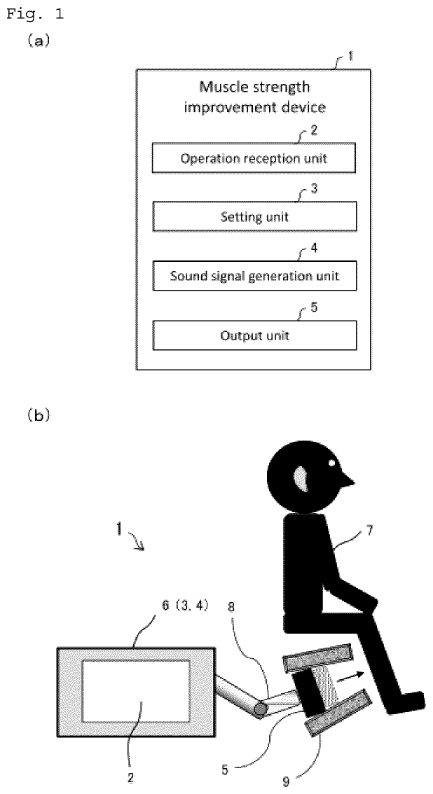

FIG. 1(a) is a block diagram illustrating the configuration of the muscle strength improvement device 1 according to the present embodiment, and FIG. 1(b) is a schematic diagram showing the configuration of the muscle strength improvement device 1. The muscle strength improvement device 1 is equipped with a function to generate sounds based on a pattern of sound stimuli designed to improve muscle strength. Hereinafter, the sound generated by the muscle strength improvement device 1 will be referred to as a “sound stimulus.”

The muscle strength improvement device 1 includes an operation reception unit 2 for receiving operations to output a sound stimulus, a setting unit 3 for configuring the sound stimulus in response to the operation, a sound signal generation unit 4 for generating a signal of the configured sound stimulus, and an output unit 5 for outputting the sound stimulus based on the generated signal.

The operation reception unit 2 is configured, for example, as a touch panel. The setting unit 3 and the sound signal generation unit 4 are built into the main body 6. The sound signal generation unit 4 has a function to generate signals of sound stimuli with frequencies that change over time, either continuously or intermittently.

The output unit 5 is a speaker that may output sound externally from the muscle strength improvement device 1 or a speaker that is connected to the muscle strength improvement device 1. The output unit 5 is provided near the area of the body where the muscle targeted for strength improvement is located. As will be described later, since the inner ear function does not contribute to the muscle strength improvement effect of the sound stimulus, the location of this area is not particularly limited and may be a location far from the ears.

For example, when the area containing the muscle targeted for strength improvement (the target area) is the arm or leg, the output unit 5 is installed near the subject 7's arm or leg. In this case, it is preferable that the output unit 5 is non-contact with the subject 7's arm or leg and that vibrations from components such as the speaker that make up the output unit 5 are not directly transmitted to the target area. In the present embodiment, the output unit 5 is supported by an adjustable arm 8. It should be noted that the target area is not limited to the arms or legs; any part of the subject's body containing skeletal muscles, including the torso, face, or other areas, can also be a target.

Furthermore, since inner ear function does not contribute to the muscle strength improvement effect of the sound stimulus, it is preferable for the muscle strength improvement device 1 to include a suppression unit 9 that suppresses the sound stimulus from reaching the subject's ears. The suppression unit 9 can be provided at any position between the output unit 5 and the ears and may be composed of a material that shields or absorbs sound.

In FIG. 1(a), each element described as a functional block for performing various processes can be implemented in hardware as circuit blocks, memory, or other LSI components, and in software as programs loaded into memory. Accordingly, it will be understood by those skilled in the art that these functional blocks can be realized in various forms, whether through hardware alone, software alone, or a combination of the two, and are not limited to any particular implementation.

As will be described in detail later, the muscle strength improvement device 1 generates a sound stimulus with a frequency that changes over time to improve muscle strength. The sound stimulus may be a continuous sound emitted continuously over time or a discontinuous sound (intermittent sound) emitted intermittently and/or periodically. The muscle strength improvement device 1 is intended to be installed as medical equipment in healthcare facilities such as hospitals and may be used, for example, to improve the symptoms of athlete patients suffering from muscle fatigue or injuries. Physicians may adjust settings such as the frequency range, the cycle time for frequency changes, and the sound pressure level according to the severity of the patient's symptoms.

The muscle strength improvement device 1 may also be marketed as a health device and used for the purpose of improving muscle strength in healthy individuals. It is preferable for the muscle strength improvement device 1 to be designed compactly for portability. By distributing the muscle strength improvement device 1 as a health device, it is expected to contribute to promoting health by strengthening the body and improving physical condition, aiding in fatigue recovery, preventing or improving locomotive syndrome, and achieving cosmetic effects through the improvement of facial muscle strength.

In the present disclosure, “improving muscle strength” refers to the presence of a significant difference (p-value less than 0.05) between the muscle strength of muscles subjected to the sound stimulus according to the present disclosure and the muscle strength of muscles not subjected to the sound stimulus, where the muscles have comparable strength prior to stimulation. Additionally, in the present disclosure, improving muscle strength is a concept that involves not only the improvement of muscle strength reduced by muscle fatigue (muscle fatigue recovery) but also the effect of strengthening muscles.

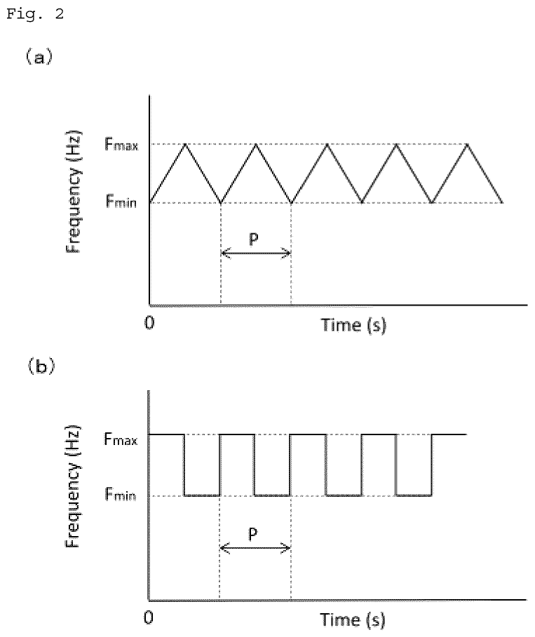

The sound stimulus generated by the muscle strength improvement device 1 is a sound stimulus with a frequency that changes over time. FIG. 2(a) is a graph showing an example of the waveform of the sound stimulus. In this sound stimulus, the frequency changes periodically with a cycle time P, but the frequency changes do not necessarily need to be periodic. The frequency is not particularly limited as long as it is within the audible range (20 Hz or higher), but it is preferably 90 Hz or lower. Additionally, the frequency range, that is, the difference between the maximum value Fmax and the minimum value Fmin, is not particularly limited but is preferably 60 Hz or lower, and more preferably 10 Hz or lower.

The sound stimulus shown in FIG. 2(a) has a frequency that changes continuously (gradually). Such a sound stimulus will hereinafter be referred to as a “sweep tone.” The frequency change in a sweep tone does not need to be linear.

Additionally, as shown by the sound stimulus in FIG. 2(b), the frequency may change discontinuously.

The sound pressure level of the sound stimulus should be at least 70 dBZ, preferably 80 dBZ or higher, and more preferably 85 dBZ or higher. In the present disclosure, “sound pressure level” refers to the unweighted sound pressure level, without auditory correction. For human subjects, the sound pressure level refers to the sound pressure level at the area where the muscle targeted for improvement is located. For mouse subjects, it refers to the sound pressure level at the location where the mouse is present. Furthermore, in the examples described below, the term “sound pressure level” refers to the level measured at the specific area intended for muscle strength improvement through sound exposure, rather than the output setting value.

In the muscle strength improvement device 1 shown in FIG. 1, it is possible to configure the sound stimulus through user operation, but it is not necessary to have a configurable setup. For example, the muscle strength improvement device may be designed to output only a single type of sound stimulus by reproducing pre-stored audio data. Alternatively, the muscle strength improvement device can be realized by inputting audio data for sound stimuli aimed at improving muscle strength into general-purpose audio equipment or a computer via telecommunications networks or storage media such as compact discs or flash memory.

### EXAMPLES

The present inventors have discovered, through experiments and other studies described below, that sounds with frequencies that change over time are sound stimuli suitable for muscle strength improvement.

### Example 1

Example 1 evaluates the effect of pure tones and sweep tones on muscle strength improvement using an assessment system that induces muscle fatigue through continuous contraction of mouse muscles via electrical stimulation. Specifically, 7 mice (9-10 weeks old, male) were prepared, and the hindlimb muscles of the mice were electrically stimulated to induce 40 contractions, during which the contractile force was measured. Subsequently, the mice were allowed a 24-hour rest period. After the rest, 3mice in the pure-tone stimulus group were exposed to a pure tone at a frequency of 85 Hz and a sound pressure level of 85 dBZ for 1 minute. Meanwhile, 4 mice in the sweep-tone stimulus group were exposed to a sweep tone with a frequency range of 80-90 Hz, varying with a cycle time of 0.1 seconds, at a sound pressure level of 85 dBZ for 1 minute. After the stimulation, the hindlimb muscles of the mice were subjected to the same electrical stimulation protocol (40 contractions), and the contractile force during this period was measured.

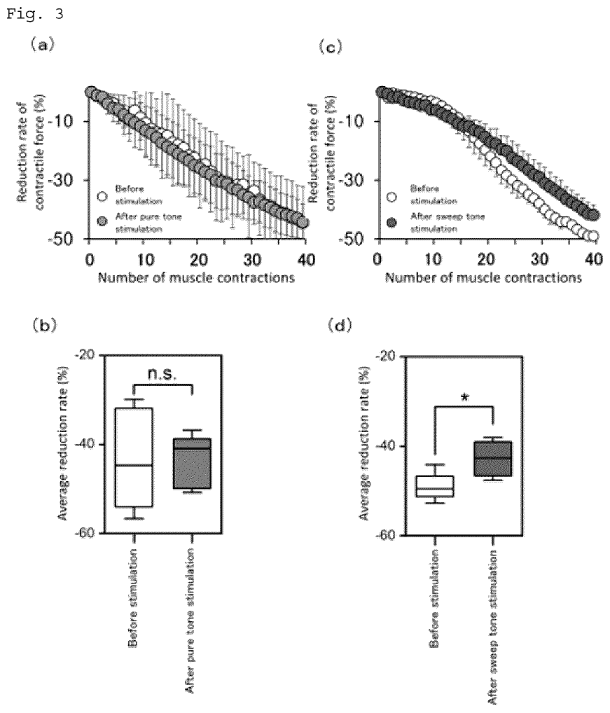

FIG. 3(a) is a graph showing the reduction rate of contractile force relative to the number of muscle contractions before (pre-rest) and after stimulation in the pure-tone stimulus group. FIG. 3(b) is a graph illustrating the average reduction rate of contractile force during muscle contractions in response to the 38th to 40th electrical stimulations before and after stimulation in the pure-tone stimulus group. From these graphs, no significant improvement in muscle strength due to pure-tone stimulation was observed.

FIG. 3(c) is a graph showing the reduction rate of contractile force relative to the number of muscle contractions before and after stimulation in the sweep-tone stimulus group. FIG. 3(d) is a graph illustrating the average reduction rate of contractile force during muscle contractions in response to the 31st to 33rd electrical stimulations before and after stimulation in the sweep-tone stimulus group. From these graphs, a significant improvement in muscle strength due to sweep tone stimulation was observed.

### Example 2

Example 2 investigated whether inner ear function contributes to the muscle strength improvement effect of sound stimulation using inner ear-impaired mice (Vestibular Lesion, VL). Specifically, 11 male mice (2.5 months old) were prepared, and inner ear function was impaired in 5 of them by intratympanic administration of an ototoxic drug. The hindlimb muscles of all 11 mice were subjected to electrical stimulation to induce 80 contractions, during which the contractile force was measured. Afterward, the mice were allowed a 24-hour rest period. Following the rest, a sweep-tone stimulus (frequency range of 80-90 Hz, cycle time of 0.1 seconds, and sound pressure level of 85 dBZ) was applied for 5 minutes. Subsequently, the hindlimb muscles of the mice were subjected to the same electrical stimulation (80 contractions), and the contractile force during this period was measured.

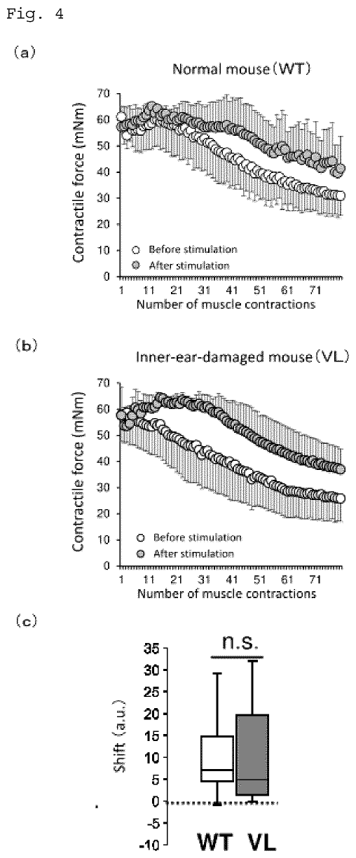

FIG. 4(a) is a graph showing the contractile force relative to the number of muscle contractions before and after stimulation in 6 normal mice (WT) without impaired inner ear function. FIG. 4(b) is a graph showing the contractile force relative to the number of muscle contractions before and after stimulation in 5 inner ear-damaged mice. FIG. 4(c) is a graph comparing the shift in the average contractile force during the last 6 contractions (75th to 80th) before and after stimulation between the normal mice and the inner ear-damaged mice.

From these results, it was observed that inner ear-damaged mice, like normal mice, also exhibited an improvement in muscle strength due to sweep tone stimulation. This indicates that inner ear function does not contribute to the muscle strength improvement effect induced by sound stimulation.

### Example 3

In Example 3, the effect of sweep tone stimulus on improving muscle weakness was evaluated using mice with reduced muscle strength induced by tail suspension (a model of locomotive syndrome). Specifically, 20 mice (7 weeks old) were prepared, and muscle strength in the hind limbs was reduced in 11 of these mice by performing tail suspension for 2 weeks. Subsequently, a first muscle strength test was conducted on all 20 mice, and the contractile force during the final muscle contraction was measured when 57 electrical stimulations were applied to the hind limbs. Afterward, tail suspension was discontinued for the 11 mice. Of these, 6 mice (tail suspension+stimulation group) with reduced muscle strength received sweep tone stimulus (sound pressure level: 85 dBZ, frequency: 60-120 Hz, cycle time: 0.1 s) for 5 minutes per day over 1 week. Meanwhile, 5 mice with reduced muscle strength (tail suspension+non-stimulation group) and 9 mice that did not undergo tail suspension (control group) did not receive any sound stimulation. One week after the first muscle strength test, a second muscle strength test was conducted on all 20 mice using the same procedure as the first test.

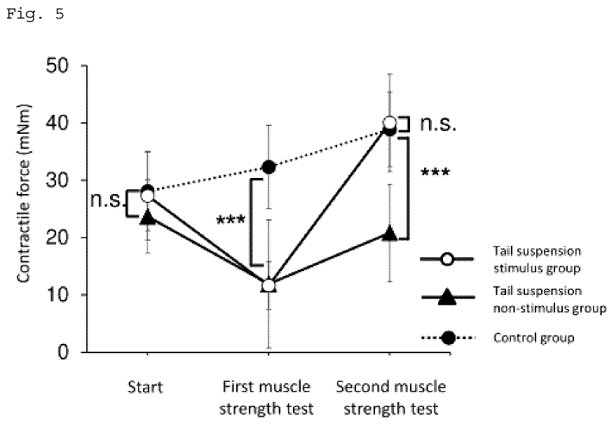

FIG. 5 is a graph showing the muscle strength (average contractile force) at the start of the experiment, the first muscle strength test, and the second muscle strength test for the tail suspension+stimulus group, the tail suspension+non-stimulus group, and the control group. From this graph, it was found that the application of a sweep tone stimulus has a significant effect on improving muscle weakness.

Furthermore, after the second muscle strength test, the soleus and plantar muscles of each mouse were stained using NADH-TR staining. Cross-sectional images of these muscles were captured, and the cross-sectional area of each muscle was measured.

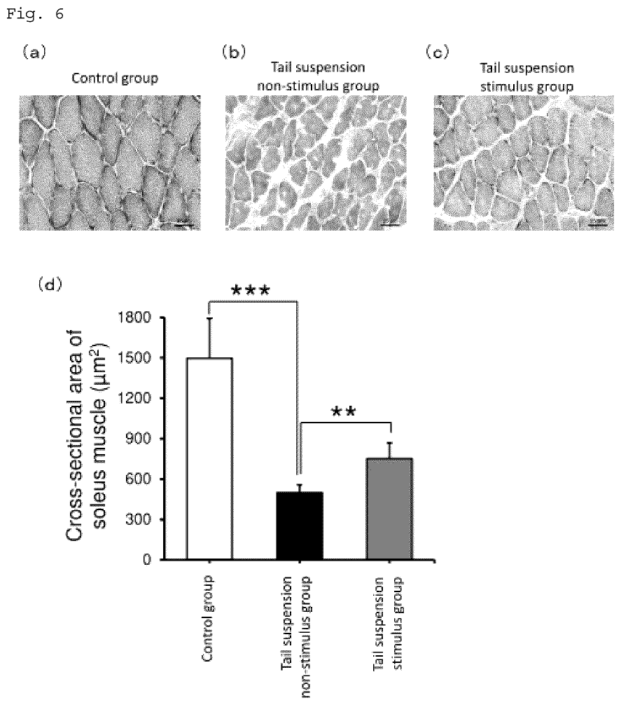

FIGS. 6(a) to 6(c) show cross-sectional images of the soleus muscle for the control group, the tail suspension+non-stimulus group, and the tail suspension+stimulus group, respectively. FIG. 6(d) is a graph showing the average cross-sectional area of the soleus muscle for the control group, the tail suspension+non-stimulus group, and the tail suspension+stimulus group. As observed in human locomotive syndrome, the cross-sectional area of the soleus muscle in the tail suspension+non-stimulus group was significantly reduced compared to the control group (non-tail-suspended group), indicating muscle atrophy. In contrast, the tail suspension+stimulus group had a larger cross-sectional area of the soleus muscle compared to the tail suspension+non-stimulus group, demonstrating that the application of a sweep tone stimulus has a recovery effect on the soleus muscle.

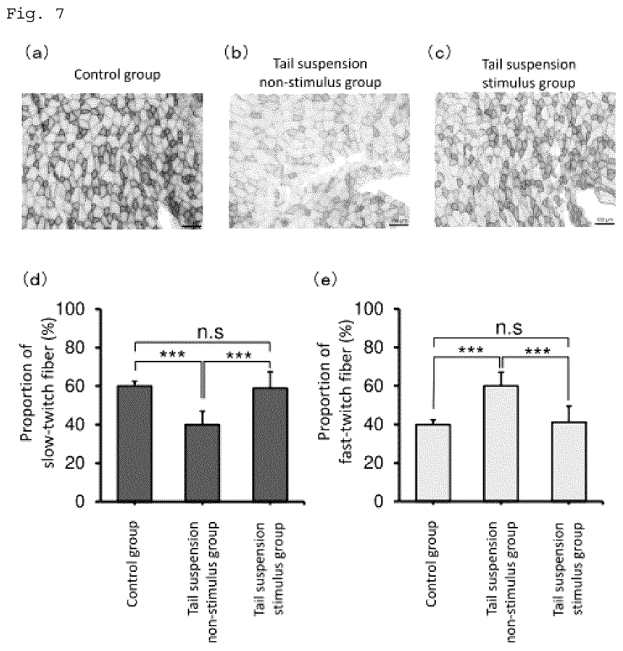

FIGS. 7(a) to 7(c) show cross-sectional images of the plantar muscle for the control group, the tail suspension+non-stimulus group, and the tail suspension+stimulus group, respectively. FIG. 7(d) is a graph showing the proportion of slow-twitch fibers in the plantar muscle for the control group, the tail suspension+non-stimulus group, and the tail suspension+stimulus group. FIG. 7(e) is a graph showing the proportion of fast-twitch fibers in the plantar muscle for these same groups. NADH-TR staining reflects mitochondrial activity within muscle fibers. In the cross-sectional images, fast-twitch fibers, which contain more glycolytic enzymes, appear darker, while slow-twitch fibers, which contain more oxidative enzymes, appear lighter. In the tail suspension+non-stimulus group, rapid muscle fatigue was observed compared to the control group (non-tail-suspended group). Regarding the proportions of slow-twitch and fast-twitch fibers, the tail suspension+stimulus group showed values comparable to those of the control group, demonstrating a significant improvement effect due to the sweep tone stimulus.

### Example 4

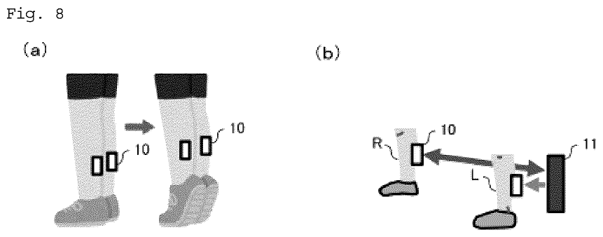

In Example 4, the recovery effect of sweep tone stimulus on muscle fatigue was evaluated in healthy human subjects. Specifically, 10 participants were instructed to perform 30 repetitions of heel-raise exercises to induce transient muscle fatigue, with two electromyographic (EMG) sensors 10 attached to their calves, as shown in FIG. 8(a). Afterward, the participants rested in a seated position, and as shown in FIG. 8(b), a speaker 11 was positioned 3 cm from the EMG sensor 10 on the left leg (L) and 40 cm from the EMG sensor 10 on the right leg (R). During the rest period, 4 participants in the pure tone stimulus group received a 5-minute pure tone stimulus at a frequency of 70 Hz, while 6 participants in the sweep tone stimulus group received a 5-minute sweep tone stimulus, with the frequency varying from 60 to 120 Hz in a 0.1-second cycle. The sound pressure level at the attachment site of the EMG sensor 10 on the left leg (L) was 85 dBZ for all participants. The sound pressure level at the attachment site of the EMG sensor 10 on the right leg (R) was 70 dBZ in the pure tone stimulus group and 65 dBZ in the sweep tone stimulus group. Subsequently, muscle fatigue for each participant was evaluated by performing spectrum analysis on the EMG data measured by the EMG sensor 10.

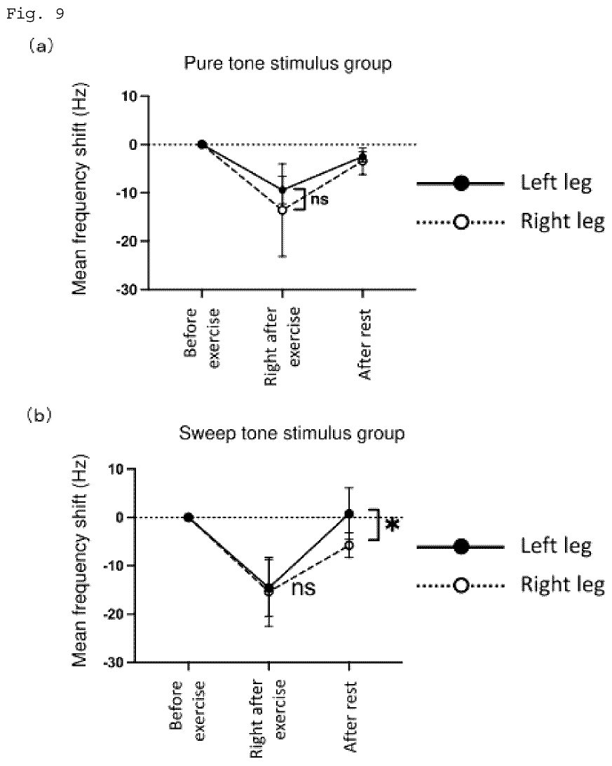

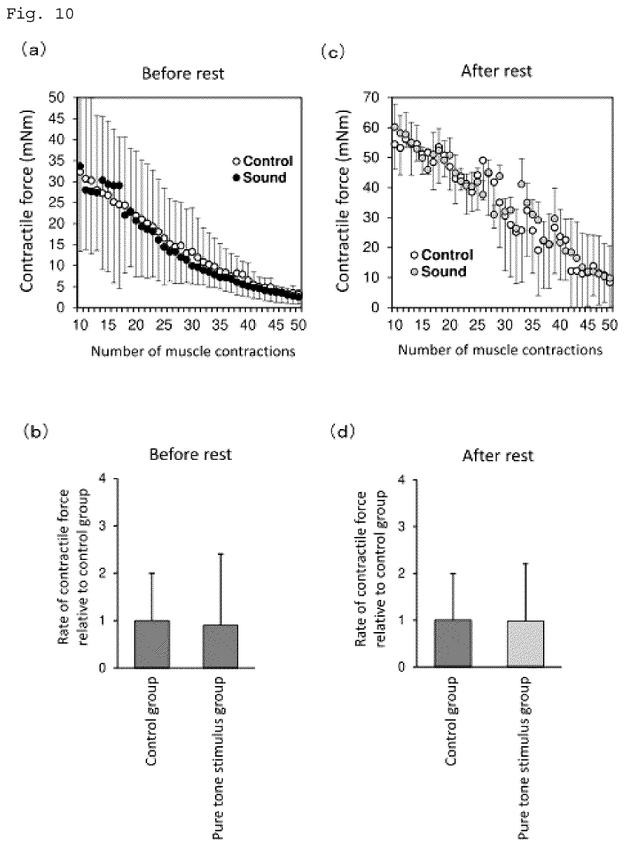

FIGS. 9(a) and 9(b) are graphs showing the muscle fatigue evaluation results for the pure tone stimulus group and the sweep tone stimulus group, respectively. The vertical axis of the graph represents the mean frequency shift of the electromyographic (EMG) signal, where smaller values indicate greater muscle fatigue. From these results, it was observed that the sweep tone stimulus group showed a significant recovery effect on muscle fatigue due to the sweep tone stimulus, whereas no such effect was observed in the pure tone stimulus group.

### Example 5

In Example 5, the objective was to screen the conditions of sound stimuli that have a muscle-strengthening effect, using mouse skin blood flow as an indicator. This involved comparing the effects of pure tones with constant frequency, as described in Patent Document 1, and sweep tones with continuously varying frequencies on the increase in skin blood flow in mice. Specifically, six male mice (3 months old) were prepared. Pure tones at a sound pressure level of 85 dBZ and sweep tones at a sound pressure level of 85 dBZ were applied as stimuli. The average rate of increase in skin blood flow in the hind limbs (calves) before and after the stimulation was measured. The frequency range of the sweep tones (the difference between the maximum and minimum values) was 10 Hz, and the period of frequency change was 0.1 seconds. The same measurements were repeated while varying the frequency of the pure tones and the frequency range of the sweep tones.

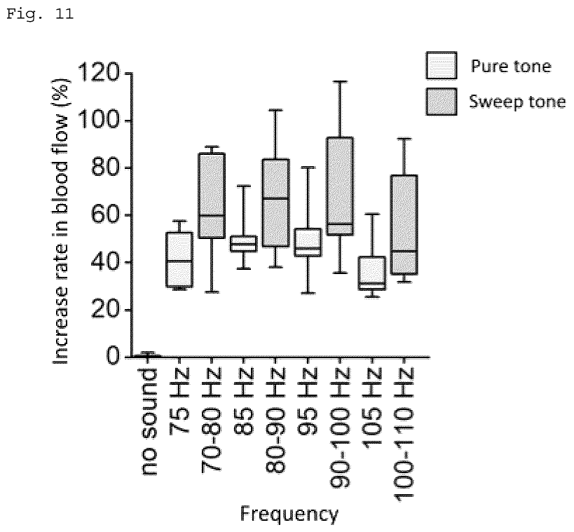

FIG. 11 is a graph showing the relationship between the frequency of sound stimuli applied to mice and the rate of increase in skin blood flow. From these results, it was found that the blood flow increase rate in mice exposed to sweep tones was greater than that in mice exposed to pure tones with a frequency equal to the median frequency of the sweep tone's range. While effects were observed even at frequencies above 100 Hz, it was found that frequencies of 90 Hz or lower, particularly sweep tones varying in the range of 80-90 Hz, exhibited remarkably higher blood flow increase effects.

Therefore, it was found that sweep tones with frequencies of 100 Hz or lower exhibited significantly higher blood flow increase effects compared to pure tones of the same frequency level.

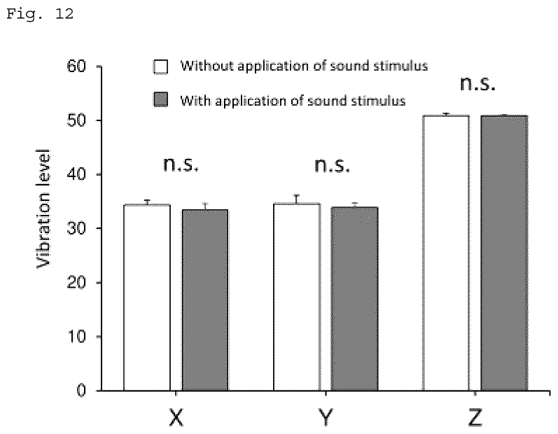

It is conceivable that the sweep tone stimuli might cause the stage on which the mice were placed to vibrate, potentially increasing blood flow in the mice due to the stage's vibration. However, as shown in FIG. 12, there were no significant differences in the vibrations of the stage along the X, Y, or Z axes, regardless of the presence or absence of sweep tone stimuli. Therefore, it was confirmed that the increase in blood flow in the mice was due to the sound stimuli and not caused by vibrations of the stage.

### Example 6

In Example 6, the relationship between the frequency change cycle (cycle time) of sweep tones and the skin blood flow increase effect was investigated. Specifically, for the six mice used in Example 5, the sound pressure level was fixed at 85 dBZ, and the frequency range was set to 80-90 Hz. Seven types of sweep tones with cycle times varying from 0.01 seconds to 10 seconds were applied as stimuli. The average rate of increase in skin blood flow in the hind limbs before and after the stimulation was measured.

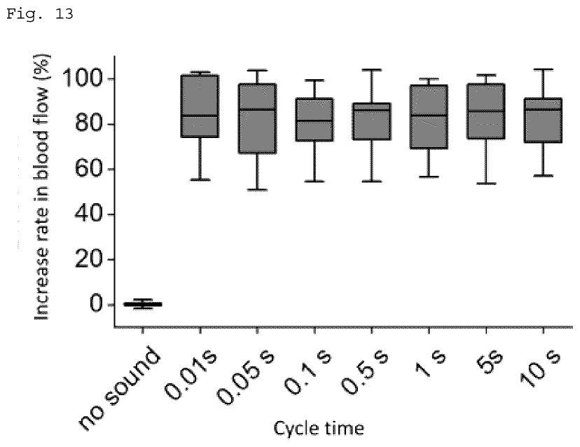

FIG. 13 is a graph showing the relationship between the cycle time of sweep tones applied to mice and the rate of increase in skin blood flow. From this graph, it was observed that the blood flow increase effect remained consistent regardless of variations in the cycle time of the sweep tones. Consequently, it was determined that the frequency changes in sweep tones may be either periodic or non-periodic.

### Example 7

In Example 7, the relationship between the frequency and frequency range (difference between maximum and minimum values) of sweep tones and their effect on increasing blood flow in muscle tissue was investigated. Specifically, three male mice (7 weeks old) were prepared, and under anesthesia, the skin tissue was removed to expose the muscle tissue. The blood flow in the muscle tissue was measured using a laser Doppler blood flow imaging device. First, blood flow was measured for 10 seconds without applying any sound stimuli, and the results of this measurement were used as the baseline. Subsequently, 12 types of sweep tones with different frequencies and frequency ranges were applied for 10 seconds each, and the blood flow in the muscle tissue during stimulation was measured.

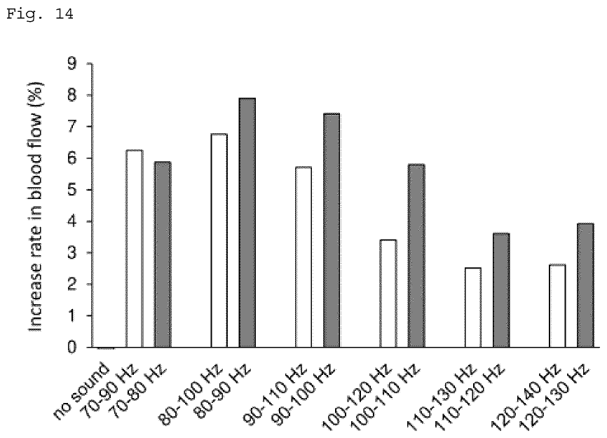

FIG. 14 is a graph showing the relationship between the frequency range of sweep tones applied to mice and the rate of increase in blood flow in muscle tissue. The horizontal axis of the graph represents the frequency range of the sweep tones, with each tone having a sound pressure level of 85 dBZ. The vertical axis represents the rate of increase in blood flow (average of three mice) from the baseline. From these results, it was observed that for sweep tones in the frequency range of 80 Hz to 130 Hz, those with a frequency range of 10 Hz exhibited a stronger blood flow increase effect compared to sweep tones with a frequency range of 20 Hz.

### Additional Notes

As described above, the embodiments and examples of the present disclosure have been explained. However, the present disclosure is not limited to the above embodiments and examples, and various modifications can be made within the scope of the claims. For example, while the above embodiments and examples provide specific numerical values for aspects such as the frequency of sound stimuli that change over time, these numerical values are not particularly limited as long as there is a significant difference in muscle strength between muscles subjected to the sound stimuli and those not subjected to the sound stimuli.

### DESCRIPTION OF REFERENCE NUMERALS

1 Muscle strength improvement device
2 Operation reception unit
3 Setting unit
4 Sound signal generation unit
5 Output unit
6 Main body
7 Subject
8 Adjustable arm
9 Suppression unit
10 Electromyographic (EMG) sensor
11 Speaker

1. A muscle strength improvement device that generates a sound stimulus for improving muscle strength,
wherein the frequency of said sound stimulus changes over time.

2. The muscle strength improvement device according to claim 1,
wherein said frequency is 140 Hz or lower.

3. The muscle strength improvement device according to claim 1,
wherein said frequency is 100 Hz or lower.

4. The muscle strength improvement device according to claim 1,
wherein the difference between the maximum value and the minimum value of said frequency is 60 Hz or lower.

5. The muscle strength improvement device according to claim 1,
wherein the difference between the maximum value and the minimum value of said frequency is 10 Hz or lower.

6. The muscle strength improvement device according to claim 1,
wherein said frequency changes periodically.

7. The muscle strength improvement device according to claim 1,
wherein said frequency changes continuously.

8. The muscle strength improvement device according to claim 1,
wherein said frequency changes with a cycle time of 0.1 seconds to 10 seconds.

9. The muscle strength improvement device according to claim 1,
further comprising an output unit for outputting said sound stimulus,
wherein said output unit is non-contact with the subject.

10. A program for causing a computer to implement a function for generating a sound stimulus to improve muscle strength,
wherein the frequency of said sound stimulus changes over time.

11. The muscle strength improvement device according to claim 1,
wherein the frequency is 70 Hz to 110 Hz, and
the difference between the maximum value and the minimum value of said frequency is 10 Hz or lower.

12. The muscle strength improvement device according to claim 1,
wherein sound is exposed at an area intended for muscle strength improvement.
